(19) United States
(12) Patent Application Publication
(10) Pub. No.: US 2009/0071171 A1
(43) Pub. Date: Mar. 19, 2009

(54) CRYOGENIC LIQUID STORAGE METHOD AND SYSTEM

(76) Inventors: Jalal Hunain Zia, Florence, SC (US); John Henri Royal, Grand Island, NY (US); Kevin Roberts, Scotia, NY (US)

Correspondence Address: PRAXAIR, INC.;LAW DEPARTMENT - M1 557, 39 OLD RIDGEBURY ROAD, DANBURY, CT, 06810-5113, US

(21) Appl. No.: 11/857,213

(22) Filed: Sep. 18, 2007

(51) Int. Cl. F17C 1/00; F25D 3/10

(52) U.S. Cl. 62/47.1

(57) ABSTRACT

A cryogenic liquid storage system and method in which cryogenic liquid is stored within an active cryogenic liquid storage tank and one or more passive cryogenic liquid storage tanks. Headspace regions of the passive cryogenic liquid storage tanks are connected to the active cryogenic liquid storage tank and the active cryogenic liquid storage tank is refrigerated to collapse the headspace vapor within the active cryogenic liquid storage tank causing the flow of headspace vapor from the headspace regions of the passive cryogenic liquid storage tanks to the active cryogenic liquid storage tank. The increased head of liquid produces a pressure differential that drives liquid from the active cryogenic liquid storage tank back to the passive cryogenic liquid storage tanks. In such manner, refrigeration applied to a single active cryogenic liquid storage tank can be used to refrigerate the passive cryogenic liquid storage tanks to prevent the venting of headspace vapor from all of the cryogenic liquid storage tanks.

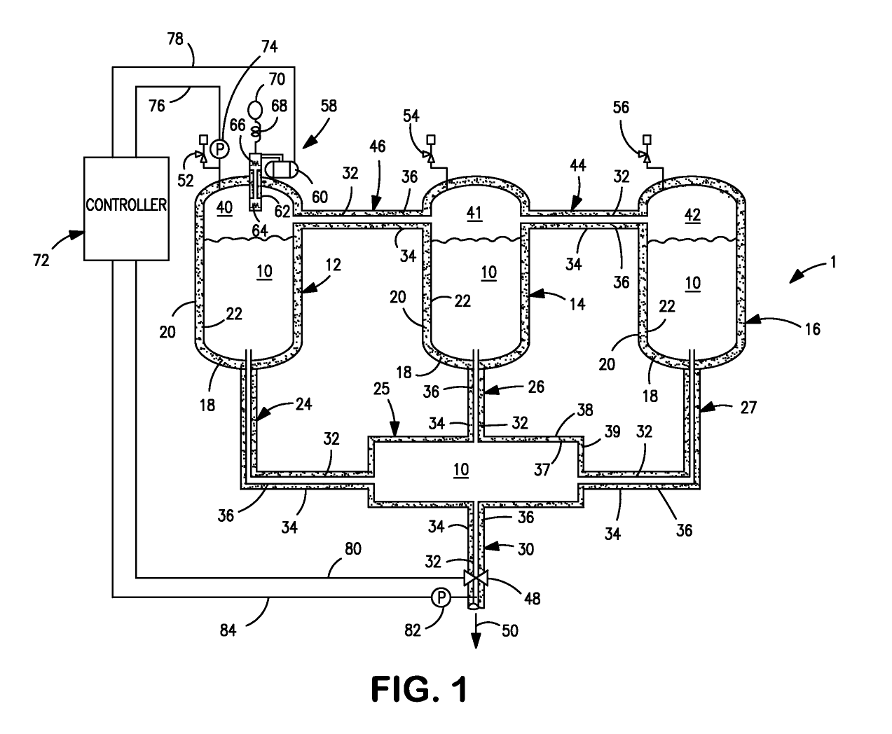

### FIELD OF THE INVENTION

The present invention relates to a method and system for storing a cryogenic liquid in a series of cryogenic liquid storage tanks in which headspace vapor in an actively refrigerated tank is condensed and the tanks are linked together so that headspace vapor flows from the passive cryogenic liquid storage tanks that are not refrigerated to the actively refrigerated cryogenic liquid storage tank to also be condensed and liquid flows from the actively refrigerated cryogenic liquid tank back to the passive cryogenic liquid storage tanks.

### BACKGROUND OF THE INVENTION

Cryogenic liquid is often stored within one or more cryogenic liquid storage tanks that each comprises insulated vessels that are typically double walled to create an insulation space to contain vacuum insulation. Even with the insulation, there exists heat leakage into the tanks that requires the tanks to be vented due to boiling of a cryogenic liquid contained in such tank. This results in a loss of valuable cryogenic liquid of approximately a quarter of a percent per day.

It is known to refrigerate cryogenic liquid storage tanks to prevent such losses. For example, U.S. Pat. No. 6,430,938 illustrates a cryogenic vessel system for containing a cryogenic liquid in which a refrigerator is provided to a stationary cryogenic liquid storage tank to condense the headspace vapor.

The same problem exists with respect to mobile tanks such as utilized in trailers and tank cars. In this regard, U.S. Pat. No. 4,718,239 provides a cryogenic liquid storage tank of the type that is meant to transport a cryogenic liquid such as liquid helium or liquid hydrogen. In order to stem the loss of the liquid contents of the tank, a lower value cryogenic liquid, such as liquid nitrogen, is housed within a separate storage space and is thermally linked to the tank retaining the value added cryogenic liquid by means of a thermal shield that is cooled by the liquid nitrogen.

As will be discussed among other advantages, the present invention provides a method and liquid storage system in which the refrigeration imparted to one of a series of such cryogenic liquid storage tanks can be used to prevent loss of the contents of all of the tanks through heat leakage into the tanks.

### SUMMARY OF THE INVENTION

In one aspect, the present invention relates to a cryogenic liquid storage method. In accordance with the method, the cryogenic liquid is stored in an active cryogenic liquid storage tank and a passive cryogenic liquid storage tank. The active and passive cryogenic liquid storage tank are coupled together such that a stream of cryogenic vapor is able to flow between headspace regions of the passive cryogenic liquid storage tank and the active cryogenic liquid storage tank and a stream of the cryogenic liquid is able to flow from the active cryogenic liquid storage tank to the passive cryogenic liquid storage tank. The active cryogenic liquid storage tank is refrigerated such that the cryogenic vapor located in an active headspace region thereof is condensed. This produces a pressure gradient under which the stream of the cryogenic vapor flows from the passive cryogenic liquid storage tank to the active cryogenic liquid storage tank. An increase in the head of the cryogenic liquid stored in the active cryogenic liquid storage tank due to the condensation of the cryogenic vapor causes the stream of the cryogenic liquid to flow from the active cryogenic liquid storage tank to the passive cryogenic liquid storage tank. Therefore, all of the tanks do not have to be refrigerated in order to stem the loss of liquid product due to heat leakage and eventual venting of the cryogenic vapor.

Refrigeration can be supplied to the active cryogenic liquid storage tank such that the pressure within the active headspace region is maintained above a delivery pressure of the cryogenic liquid and below a maximum allowable working pressure of the active cryogenic liquid storage tank.

In another aspect, the present invention provides a cryogenic liquid storage system in which an active cryogenic liquid storage tank and a passive cryogenic liquid storage tank are provided to store the cryogenic liquid. The active and passive cryogenic liquid storage tanks are coupled together such that a stream of the cryogenic vapor is able to flow between the headspace region of the passive cryogenic liquid storage tank and the active cryogenic liquid storage tank and a stream of the cryogenic liquid is able to flow from the active cryogenic liquid storage tank to the passive cryogenic liquid storage tank.

A refrigerator is operatively associated with the active cryogenic liquid storage tank such that cryogenic vapor located in an active headspace region thereof is condensed. This produces a pressure gradient under which the stream of the cryogenic vapor flows from the passive cryogenic liquid storage tank to the active cryogenic liquid storage tank. An increase in the head of the cryogenic liquid stored in the active cryogenic liquid storage tank due to condensation of the cryogenic vapor causes the stream of cryogenic liquid to flow from the active cryogenic liquid storage tank to the passive cryogenic liquid storage tank.

A pressure transducer can be located in an active headspace region of the active cryogenic liquid storage tank to generate a signal referable to the pressure within the active headspace region. A controller, connected to the pressure transducer, is responsive to the signal generated by the pressure transducer and is configured to activate the refrigerator such that the pressure within the active headspace region is maintained above a delivery pressure of the cryogenic liquid and below a maximum allowable working pressure of the active cryogenic liquid storage tank.

In either of the aspects of the present invention, discussed above, the refrigerator can be of cryocooler that can be positioned within an active headspace region of the active cryogenic liquid storage tank to condense the cryogenic vapor located within the active cryogenic liquid storage tank. Further, the passive cryogenic liquid storage tank can be one passive cryogenic liquid storage tank of a plurality of passive cryogenic liquid storage tanks. The headspace region of the plurality of passive cryogenic liquid storage tanks can be connected in series so that streams of the cryogenic vapor are able to flow between headspace regions of the passive cryogenic liquid storage tanks in a direction such that the cryogenic vapor flows from a downstream passive cryogenic liquid storage tank to an upstream passive cryogenic liquid storage tank. The plurality of passive cryogenic liquid storage tanks can also be connected so that the streams of the cryogenic liquid flow from the active cryogenic liquid storage tanks in parallel to the passive cryogenic liquid storage tanks.

### BRIEF DESCRIPTION OF THE DRAWING

While the specification concludes with claims distinctly pointing out the subject matter that Applicants regard as their invention, it is believed that the invention will be better understood when taken in connection with the accompanying sole FIGURE that illustrates a cryogenic liquid storage system for carrying out a method in accordance with the present invention.

### DETAILED DESCRIPTION

With reference to the sole FIGURE, a cryogenic liquid storage system 1 is provided for storing a cryogenic liquid 10. Cryogenic liquid storage system 1 is provided with an active cryogenic liquid storage tank 12 and passive cryogenic liquid storage tanks 14 and 16. It is to be noted that as used herein and in the claims, the term “cryogenic liquid” means any substance that is a gas or a vapor at standard ambient temperature and pressure conditions and includes such substances as carbon dioxide, natural gas, nitrogen, oxygen, argon and the like.

Each of the active cryogenic liquid storage tank 12 and the two passive cryogenic liquid storage tanks 14 and 16 are vacuum insulated tanks containing vacuum insulation 18 that is located within an insulation space defined between an outer tank 20 and an inner tank 22. It is to be noted, however, that any liquid storage tank that is capable of storing a liquid cryogen could be utilized in connection with the present invention. The active cryogenic liquid storage tank 12 feeds cryogenic liquid 10 through a vacuum insulated line 24 to a vacuum insulated header 25. Similarly, passive cryogenic liquid storage tanks 14 and 16 feed cryogenic liquid 10 to insulated header 25 through vacuum insulated lines 26 and 27. Cryogenic liquid is then delivered from insulated header 25 through a vacuum insulted outlet line 30 for use in a downstream process or for further offsite distribution.

Each of the vacuum insulted lines 24, 26, 28 and 30 has inner and outer pipes 32 and 34 enclosing vacuum insulation 36. Similarly, insulated heater 25 has inner and outer pipes 37 and 38 to retain vacuum insulation 39. Vacuum insulation 18, 36 and 39 can be perolite, aerogel or other known vacuum insulations in which the insulation space containing the insulation is evacuated.

Active cryogenic liquid storage tank 12 has a headspace region 40. Similarly, the passive cryogenic liquid storage tanks 14 and 16 have headspace regions 41 and 42. Headspace regions 40, 41 and 42 are serially connected so that the headspace region 42 of cryogenic liquid storage tank 16 is connected to headspace region 41 of passive cryogenic liquid storage tank 14 by way of a vacuum insulated pipe 44 and headspace region 41 of passive cryogenic liquid storage tank 14 is connected to headspace region 40 of active cryogenic liquid storage tank 12 by vacuum insulted pipe 46. Vacuum insulated pipes 44 and 46, as described above, contains an inner pipe 32, an outer pipe 34 and vacuum insulation 36 located between the two pipes.

When cryogenic liquid 10 is to be dispensed, a control valve 48 is set in an open position and liquid cryogen simultaneously flows from the active cryogenic liquid storage tank 12, the passive cryogenic liquid storage tanks 14 and 16 to header 25 and then out of vacuum insulated pipe 28 as indicated by liquid stream 50. Although not illustrated, the active cryogenic liquid storage tank 12 and the two passive cryogenic liquid storage tanks 14 and 16 can be filled via separate inlets provided for such purposes.

During idle periods, when liquid stream 50 is not being dispensed, heat leakage into the active cryogenic liquid storage tank 12 and the passive cryogenic liquid storage tanks 14 and 16 will cause the liquid cryogen 10 to vaporize into headspace regions 40, 41 and 42 of such tanks. Eventually, pressure is reached at which the vapor must be vented and for such purposes, preset pressure relief valves 52, 54 and 56 are provided for active cryogenic liquid storage tank 12 and passive cryogenic liquid storage tanks 12 and 16, respectively. The pressure relief valves 52, 54 and 56 are set to open at the maximum allowable working pressure of the cryogenic liquid storage tanks 12, 14 and 16.

In accordance with the present invention, in order to minimize the amount of cryogen that is vented, the headspace region 40 is refrigerated by the illustrated pulse tube refrigerator 54. Active cryogenic liquid storage tank 12 is refrigerated and hence it is termed “active” as opposed to passive cryogenic liquid storage tanks 14 and 16 termed “passive” because they are not refrigerated. The refrigeration provided by pulse tube refrigerator 54 collapses headspace vapor within headspace region 40. This creates a pressure differential which drives headspace vapor contained in the downstream passive cryogenic liquid storage tank 14 by means of the vacuum insulated line 46 into headspace region 40. As headspace vapor within headspace region 41 is driven into headspace region 40 headspace vapor within the downstream headspace region 42 is driven towards upstream headspace region 41 through vacuum insulated pipe 44. Although not illustrated, headspace region 42 could be directly connected to headspace region 40 in parallel with headspace region 41 for such purposes.

The collapse of headspace vapor within headspace region 40 increases the liquid level of liquid cryogen 10 within active cryogenic liquid storage tank 12. This head creates a pressure differential which causes the liquid cryogen 10 stored within active cryogenic liquid storage tank 12 to flow through vacuum insulated line 24 and header 10 into passive cryogenic liquid storage tanks 14 and 16 via vacuum insulated lines 26 and 27. Again, it is possible for passive cryogenic liquid storage tank 16 to be directly connected to active cryogenic liquid storage tank 10 for such purposes. Hence, refrigeration being supplied to active cryogenic liquid storage tank 12 is also condensing headspace vapor within passive cryogenic liquid storage tanks 14 and 16 so that venting of valuable cryogenic product is minimized.

As illustrated, pulse tube refrigerator 58 contains a pressure wave generator 60 which, as known in the art, can be a free piston device that generates a pressure wave within a pulse tube 62. Refrigeration is supplied because heat conducted within cold heat exchanger 64 is conducted by the oscillating wave within pulse tube 6 to after cooler and warm end heat exchanger 66. In the illustration, pulse tube refrigerator 58 is provided with an inertance tube 68 and a compliance volume 70. However, it is to be noted that the present invention is not limited to such a cryocooler, for instance, a Sterling cycle cold finger could be utilized as well as a Gifford-McMahon refrigerator or even a coil containing a refrigerant circulated into the headspace 40 to collapse the headspace vapor. Similarly, any one of the foregoing refrigerators could be provided to subcool the cryogenic liquid 10 contained within active cryogenic liquid storage tank 12 to collapse the headspace vapor within headspace region 40 of active cryogenic liquid storage tank 12. It is further understood that although a single active cryogenic liquid storage tank 12 is illustrated in connection with two passive cryogenic liquid storage tanks 14 and 16, there could be, within the scope of the present invention, any number of passive cryogenic liquid storage tanks all connected to the active cryogenic liquid storage tank 12 or in fact with intermediate active cryogenic liquid storage tanks 12 to provide efficient refrigeration.

There are several possible modes of operation that are contemplated in the present invention with respect to pulse tube refrigerator 58 or for that matter any other refrigeration system used in connection with the present invention. For example, pulse tube refrigerator 58 could be continually operated or intermittently operated. In a continual operation, the pulse tube refrigerator 58 would be designed to deliver refrigeration at a fixed rate. Intermittent operation can involve feed back control in which headspace region 40 and therefore, headspace regions 41 and 42 are maintained within a pressure range. The pressure range can be set at the delivery pressure of liquid product stream 50. However, this is not efficient in that this would require more refrigeration to be supplied than if the pressure within the headspace regions 40, 41, 42 were maintained at a pressure range higher than the delivery pressure but lower than the maximum operation pressure of the cryogenic liquid storage tanks 12, 14 and 16. Delivery pressure of the liquid product stream 50 is then controlled by control valve 48.

The maintenance of pressure within headspace regions 40, 31 and 42 to be within a pressure range above the delivery pressure of liquid product stream 50 can be accomplished with the use of a controller 72 that senses the headspace pressure within headspace region 40 via a pressure transducer 74. A signal generated by pressure transducer 74, that is referable to the pressure, is fed into controller 72 by way of an electrical connection 76. Controller 72, which can be a programmable logic controller or other controller, is programmed so that when the pressure rises above a set point, electrical current is supplied to pressure wave generator 60. For example controller 72 could feed a control signal through electrical connection 78 to a switch to operate pulse tube refrigerator 58 or, as would be well known in the art, another controller to ramp up the operation of pulse tube refrigerator 58. In such case, the set point is selected to be within a range below the maximum operational pressure of the cryogenic liquid storage tanks 12, 14 and 16 and above the delivery pressure of liquid product stream 50. When liquid is to be dispensed, the forgoing controller 72 renders the cryocooler 58 inactive and functions to operate control valve 48 to dispense the liquid product stream 50. Control valve 48, that can be an electrically or pneumatically operated valve, is controlled by controller 72 by means of an electrical connection 80. The downstream pressure as measured by a pressure transducer 82 feeds a signal 84 referable to the pressure sensed by pressure transducer 82 to controller 72. Controller 72 is provided with an input that serves as set point to control valve 48 in a known manner and thereby control the outlet pressure of liquid stream 50. It is to be noted that controller 72 could be part of a control system that controlled an entire facility in which cryogenic liquid storage system 1 were housed. Although not illustrated, a pressure building circuit could be used in connection with the cryogenic liquid storage tanks 12, 14 and 16 to maintain tank pressure above such set point used in connection with control valve 48 and during dispensing.

While the present invention has been described with reference to a preferred embodiment, as will occur to those skilled in the art, numerous changes, additions and omissions may be made without departing from the spirit and the scope of the present invention as set forth in the appended claims.

We claim:

1. A cryogenic liquid storage method comprising:
storing the cryogenic liquid in an active cryogenic liquid storage tank and a passive cryogenic liquid storage tank, the active and passive cryogenic liquid storage tank coupled together such that a stream of the cryogenic vapor is able to flow between headspace regions of the passive cryogenic liquid storage tank and the active cryogenic liquid storage tank and a stream of the cryogenic liquid is able to flow from the active cryogenic liquid storage tank to the passive cryogenic liquid storage tank; and
refrigerating the active cryogenic liquid storage tank such that cryogenic vapor located in a active headspace region thereof is condensed, thereby to produce a pressure gradient under which the stream of the cryogenic vapor flows from the passive cryogenic liquid storage tank to the active cryogenic liquid storage tank and an increase in the head of the cryogenic liquid stored in the active cryogenic liquid storage tank due to the condensation of the cryogenic vapor causes the stream of the cryogenic liquid to flow from the active cryogenic liquid storage tank to the passive cryogenic liquid storage tank.

2. The method of claim 1, wherein:
the passive cryogenic liquid storage tank is one passive cryogenic liquid storage tank of a plurality of passive cryogenic liquid storage tanks;
the plurality of passive cryogenic liquid storage tanks having headspace regions connected in series so that streams of the cryogenic vapor are able to flow between headspace regions of passive cryogenic liquid storage tanks in a direction such that the cryogenic vapor flows from a downstream passive cryogenic liquid storage tank to an upstream passive cryogenic liquid storage tank; and
the plurality of passive cryogenic liquid storage tanks are connected so that streams of the cryogenic liquid flow from the active cryogenic liquid storage tank, in parallel, to the passive cryogenic liquid storage tanks.

3. The method of claim 1, wherein the active cryogenic liquid storage tank is refrigerated with a cryocooler positioned to condense the cryogenic vapor located within the active headspace region of said active cryogenic liquid storage tank.

4. The method of claim 1 or claim 3, wherein refrigeration is supplied to the active cryogenic liquid storage tank such that pressure within the active headspace region is maintained above a delivery pressure of the cryogenic liquid and below a maximum allowable working pressure of the active cryogenic liquid storage tank.

5. The method of claim 4, wherein:
the passive cryogenic liquid storage tank is one passive cryogenic liquid storage tank of a plurality of passive cryogenic liquid storage tanks; and
the plurality of passive cryogenic liquid storage tanks have headspace regions connected in series so that streams of the cryogenic vapor are able to flow between headspace regions of passive cryogenic liquid storage tanks in a direction such that the cryogenic vapor flows from a downstream passive cryogenic liquid storage tank to an upstream passive cryogenic liquid storage tank and the plurality of passive cryogenic liquid storage tanks connected so that streams of the cryogenic liquid flow from the active cryogenic liquid storage tank, in parallel, to the passive cryogenic liquid storage tanks.

6. A cryogenic liquid storage system comprising:
an active cryogenic liquid storage tank and a passive cryogenic liquid storage tank to store the cryogenic liquid, the active and passive cryogenic liquid storage tank coupled together such that a stream of the cryogenic vapor is able to flow between headspace regions of the passive cryogenic liquid storage tank and the active cryogenic liquid storage tank and a stream of the cryogenic liquid is able to flow from the active cryogenic liquid storage tank to the passive cryogenic liquid storage tank; and
a refrigerator operatively associated with the active cryogenic liquid storage tank such that cryogenic vapor located in a active headspace region is condensed, thereby to produce a pressure gradient under which the stream of the cryogenic vapor flows from the passive cryogenic liquid storage tank to the active cryogenic liquid storage tank and an increase in the head of the cryogenic liquid stored in the active cryogenic liquid storage tank due to the condensation of the cryogenic vapor causes the stream of the cryogenic liquid to flow from the active cryogenic liquid storage tank to the passive cryogenic liquid storage tank.

7. The cryogenic liquid storage system of claim 6, wherein:
the passive cryogenic liquid storage tank is one passive cryogenic liquid storage tank of a plurality of passive cryogenic liquid storage tanks;
headspace regions of the plurality of passive cryogenic liquid storage tanks are connected in series so that streams of the cryogenic vapor are able to flow between headspace regions of passive cryogenic liquid storage tanks in a direction such that the cryogenic vapor flows from a downstream passive cryogenic liquid storage tank to an upstream passive cryogenic liquid storage tank; and
the plurality of passive cryogenic liquid storage tanks are also connected so that streams of the cryogenic liquid flow from the active cryogenic liquid storage tank, in parallel, to the passive cryogenic liquid storage tanks.

8. The cryogenic liquid storage system of claim 6, wherein the refrigerator is a cryocooler positioned within the active headspace region thereof to condense the cryogenic vapor located within said active cryogenic liquid storage tank.

9. The cryogenic liquid storage system of claim 6 or claim 8, wherein:
a pressure transducer is located in the active headspace region of the active cryogenic liquid storage tank to generate a signal referable to the pressure within the active headspace region; and
a controller is connected to the pressure transducer and is responsive to the signal generated by the pressure transducer, the controller configured to activate the refrigerator such that the pressure within the active headspace region is maintained above a delivery pressure of the cryogenic liquid and below a maximum allowable working pressure of the active cryogenic liquid storage tank.

10. The cryogenic liquid storage system of claim 9, wherein:
the passive cryogenic liquid storage tank is one passive cryogenic liquid storage tank of a plurality of passive cryogenic liquid storage tanks;
headspace regions of the plurality of passive cryogenic liquid storage tanks are connected in series so that streams of the cryogenic vapor are able to flow between headspace regions of passive cryogenic liquid storage tanks in a direction such that the cryogenic vapor flows from a downstream passive cryogenic liquid storage tank to an upstream passive cryogenic liquid storage tank; and
the plurality of passive cryogenic liquid storage tanks are also connected so that streams of the cryogenic liquid flow from the active cryogenic liquid storage tank, in parallel, to the passive cryogenic liquid storage tanks.
